(19) United States
(12) Patent Application Publication
(10) Pub. No.: US 2006/0031923 A1
(43) Pub. Date: Feb. 9, 2006

(54) Access control list attaching system, original content creator terminal, policy server, original content data management server, program and computer readable information recording medium

(76) Inventor: Yoichi Kanai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/195,775

(22) Filed: Aug. 3, 2005

(30) Foreign Application Priority Data
Aug. 4, 2004 (JP) 2004-227911

(51) Int. Cl. H04L 9/00

(52) U.S. Cl. 726/1

(57) ABSTRACT

An access control list attaching system in which an original content creator terminal for creating original content data, a policy server producing a security policy file concerning the original content data and holding it in a storage part and a right management server managing a right concerning the original content data are connected via a communication network. The policy server includes an access control list generating part generating an access control list concerning the original content data based on an attribute of the security concerning the original content data and the security policy file in which the security policy is described.

### BACKGROUND OF THE INVENTION

1. Field of the Invention

The present invention relates to an access control list attaching system, an original content creator terminal, a policy server, an original content data management server, a program and a computer readable information recording medium.

2. The Description of the Related Art

In a DRM (digital rights management services), an ACL (access control list) is given to document content data itself, and therewith, an access right is managed, which is different from a manner in which a file system of an OS (operating system) manages the ACL. Windows (registered trademark) RMS (rights management services) is a typical example of DRM technology (see “Technical Outline of Windows Rights Management Services” [online] [acquired on Jul. 27, 2004]<http:/www.micorsoft.com/japan/windowsserver2003/techinf o/overview/rementerprisewp.mspx>, for example).

Further, a system is proposed in which an ACL is given to document content data after it is encrypted, and thus, even when the document content data is illegally sold, a key required to decipher the content data is not acquired by a user who does not have a proper right (see Japanese Laid-open Patent Applications Nos. 2004-038974 and 2004-046856, for example).

### SUMMARY OF THE INVENTION

However, in a DRM system in the prior art, it is assumed that a document creator arbitrarily attaches an ACL. However, in this system, a user may fail to attach an ACL, and thus, a security hole may occur. In term of systematic security management, an ACL should be attached to document content data according to a security policy such as an organization's security management rule or such.

The present invention has been devised in consideration of this point, and an object of the present invention is to provide a system in which an ACL is attached to document content data according to a security policy of an organization.

In order to achieve this object, according to the present invention, in an access control list attaching system in which an original content creator terminal for creating original content data, a policy server producing a security policy file concerning the original content data and holding it in a storage part and a right management server managing a right concerning the original content data are connected via a communication network, the policy server includes an access control list generating part generating an access control list concerning the original content data based on an attribute of a security concerning the original content data and a security policy file in which the security policy is described.

In this system, an ACL can be attached to document content data according to a security policy of an organization.

The same object may be achieved in a form of an original content creator terminal, a policy server, an original content data management server, a program or a computer readable information recording medium storing therein the program.

### BRIEF DESCRIPTION OF THE DRAWINGS

Other objects and further features of the present invention will become more apparent from the following detailed description when read in conjunction with the accompanying drawings:

FIG. 1 shows a configuration example of a document ACL attaching system;

FIG. 2 shows a hardware configuration of one example of an original content creator terminal;

FIG. 3 shows a hardware configuration of one example of a policy server;

FIG. 4 shows a hardware configuration of one example of a right management server:

FIG. 5 shows a functional configuration of the original content creator terminal;

FIG. 6 shows a functional configuration of the policy server;

FIG. 7 shows a functional configuration of the right management server;

FIG. 8 illustrates document ACL setting processing;

FIG. 9 shows an example of a security policy of an organization;

FIG. 10 shows one example of a policy file 62;

FIG. 11 shows one example of a security attribute setting page;

FIG. 12 shows one example of a structure of ACE;

FIG. 13 shows one example of a SOAP request;

FIG. 14 shows one example of a SOAP response;

FIG. 15 shows another functional configuration of the original content creator terminal;

FIG. 16 shows another functional configuration of the policy server;

FIG. 17 shows another functional configuration of the right management server;

FIG. 18 illustrates other document ACL setting processing;

FIG. 19 shows one example of a document registration page;

FIG. 20 shows another document ACL attaching system;

FIG. 21 shows a hardware configuration of one example of a document management server;

FIG. 22 shows another functional configuration of the original content creator terminal;

FIG. 23 shows another functional configuration of the policy server;

FIG. 24 shows another functional configuration of the right management server;

FIG. 25 shows a functional configuration of the document management server;

FIG. 26 shows other document ACL setting processing;

FIG. 27 shows another functional configuration of the policy server;

FIG. 28 shows another functional configuration of the document management server; and

FIG. 29 shows other document ACL setting processing.

### DETAILED DESCRIPTION OF THE PREFERRED EMBODIMENTS

Embodiments of the present invention are described with reference to figures.

A first embodiment of the present invention is described.

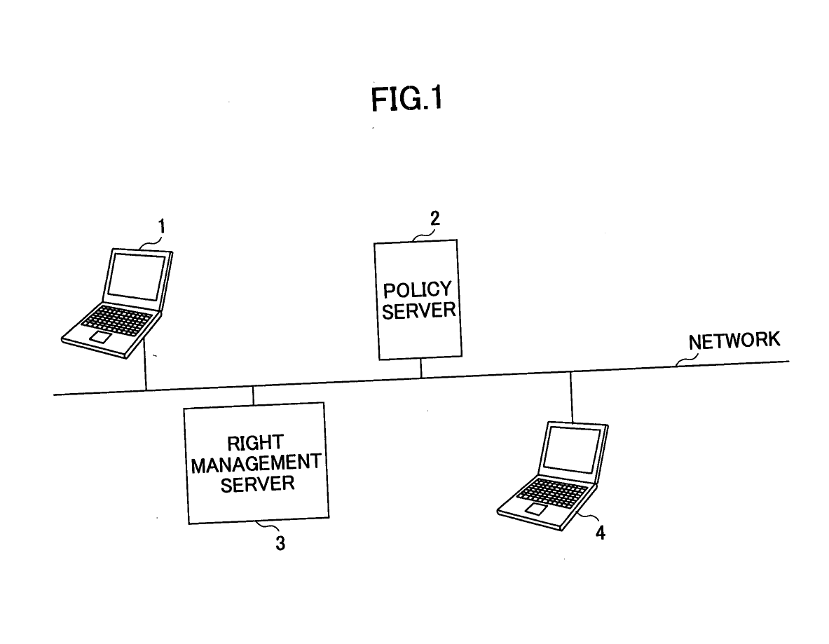

FIG. 1 shows a configuration example of a document ACL attaching system according to the first embodiment of the present invention. As shown, the document ACL attaching system includes an original content creator terminal 1, a policy server 2, a right management server 3 and a reader terminal 4, which are connected via a home network,

The original content creator terminal 1 is a terminal with which original content data is created. The policy server 2 is a server for holding a policy set by a manager or such, in a form of a policy file, described later. The right management server 3 is a server for managing a right of a document such as an access right, access time limit and so forth. The right management server 3 may be executed with the use of Windows RMS or such. The reader terminal 4 is a terminal with which a reader uses protected content data by acquiring it, reading it, or so.

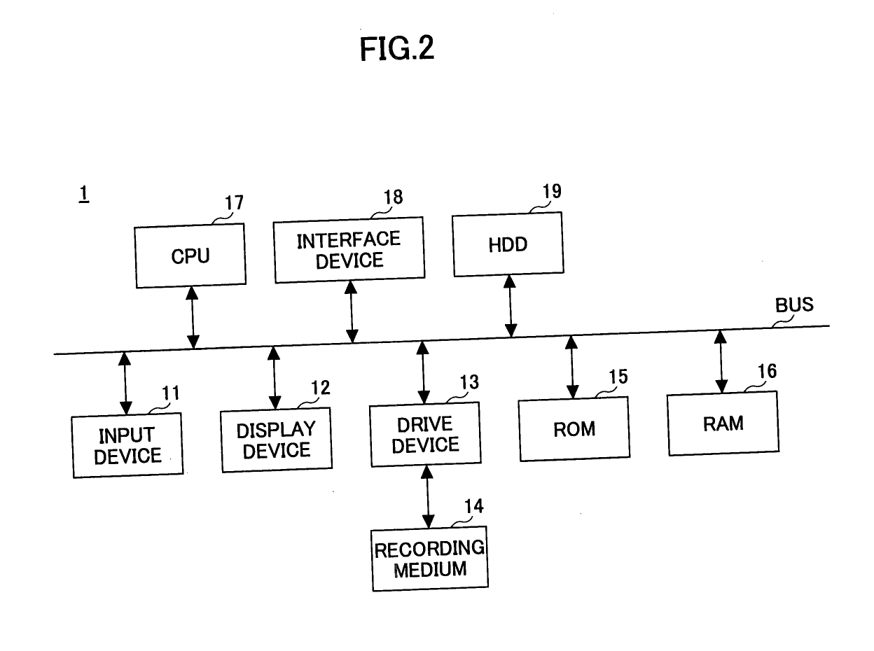

FIG. 2 shows one example of a hardware configuration of the original content creator terminal 1.

As shown, the original content creator terminal 1 includes an input device 11, a display device 12, a drive device 13, a ROM (read only memory) 15, a RAM (random access memory) 16, a CPU (central processing unit) 17, an interface device 18 and an HDD (hard disk drive) 19, which are mutually connected via a bus.

The input device 11 includes a keyboard, a mouse and so forth with which a user of the original content creator terminal 1 operates for inputting various operation signals. The display device 12 includes a display device used by the user, and displays various sorts of information. The interface device 18 is an interface for connecting the original content creator terminal 1 with a communication network or such.

A program corresponding to each of functions of the original content creator terminal 1 described later is provided to the original content creator terminal 1 by means of a computer readable information recording medium 14 such as a CD-ROM, for example, or, downloaded through the communication network. The information recording medium 14 is set in the drive device 13, and the program is installed in the HDD 19 through the drive device 13 from the information recording medium 14.

The ROM 15 is used to store data. The RAM 16 is used to store the program read out from the HDD 19 upon starting up of the original content creator terminal 1, for example. The CPU 17 executes processing according to the program stored in the RAM 16.

The HDD 19 is used to store programs, data, a security attribute list, security attributes, original content data, an encryption key, protected content data or such according to the first embodiment of the present invention.

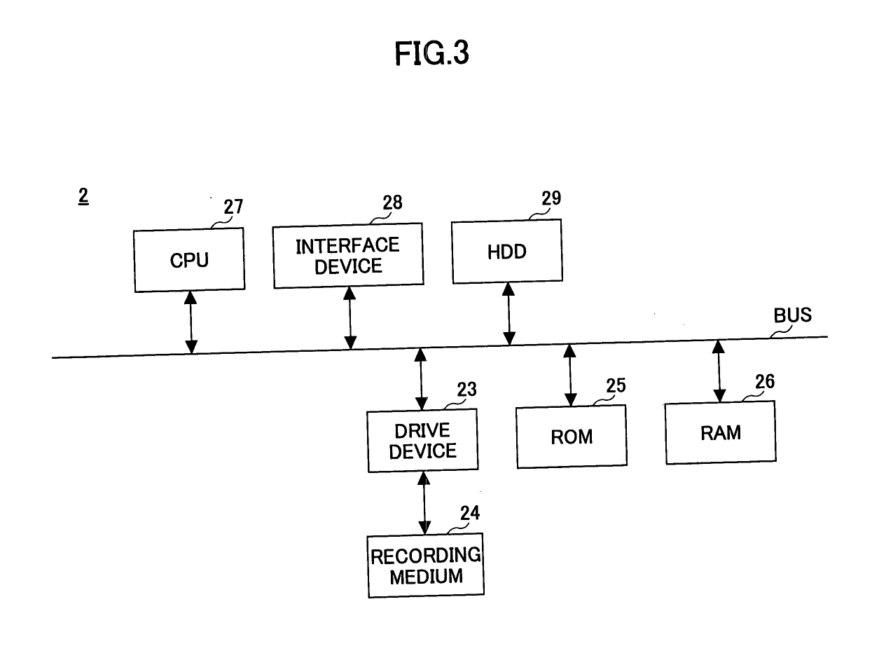

With reference to FIG. 3, one example of a hardware configuration of the policy server 2 is described.

The policy server 2 includes a drive device 23, a ROM 25, a RAM 26, a CPU 27, an interface device 28 and a HDD 29, mutually connected via a bus.

The interface device 28 is an interface to connect the policy server 2 to a communication network or such.

A program corresponding to each of functions of the policy server 2 described later is provided to the policy server 2 by means of a computer readable information recording medium 24 such as a CD-ROM, for example, or, downloaded through the communication network. The information recording medium 24 is set in the drive device 23, and the program is installed in the HDD 29 through the drive device 23 from the information recording medium 24.

The ROM 25 is used to store data. The RAM 26 is used to store the program read out from the HDD 29 upon starting up of the policy server, for example. The CPU 27 executes processing according to the program stored in the RAM 26.

The HDD 29 is used to store programs, policy files 62 or such. However, in a second embodiment described later for example, the HDD 29 is used to store, other than the programs or the policy files 62, original content data, an encryption key, protected content data or such.

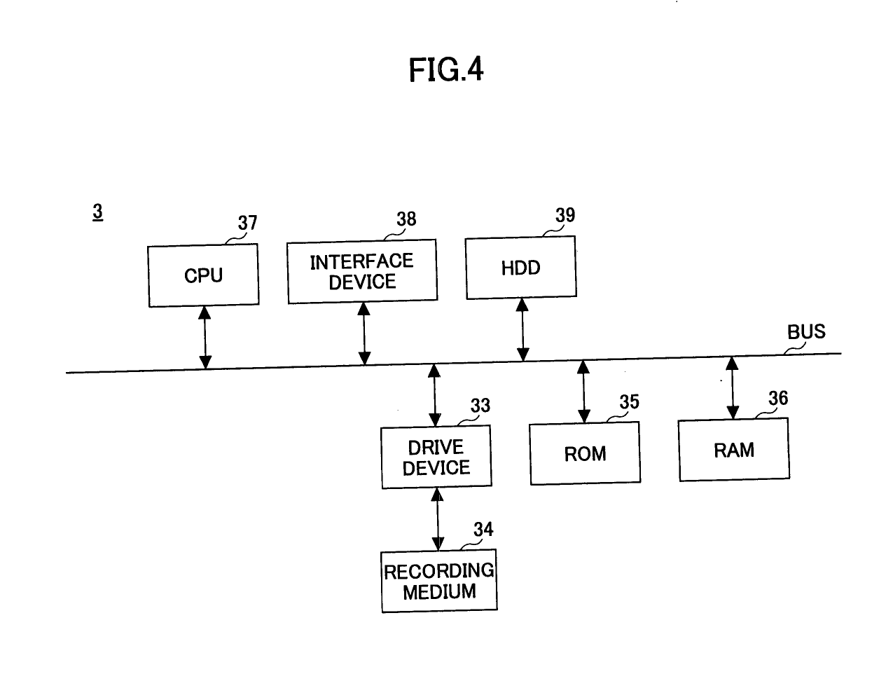

With reference to FIG. 4, one example of a hardware configuration of the right management server 3 is described.

The right management server 3 includes a drive device 33, a ROM 35, a RAM 36, a CPU 37, an interface device 38 and a HDD 39, mutually connected via a bus.

The interface device 38 is an interface to connect the right management server 3 to a communication network or such.

A program corresponding to each of functions of the right management server 3 described later is provided to the right management server 3 by means of a computer readable information recording medium 34 such as a CD-ROM, for example, or, downloaded through the communication network. The information recording medium 34 is set in the drive device 33, and the program is installed in the HDD 39 through the drive device 33 from the information recording medium 34.

The ROM 35 is used to store data. The RAM 36 is used to store the program read out from the HDD 39 upon starting up of the right management server 3, for example. The CPU 37 executes processing according to the program stored in the RAM 36.

The HDD 39 is used to store programs, data and so forth.

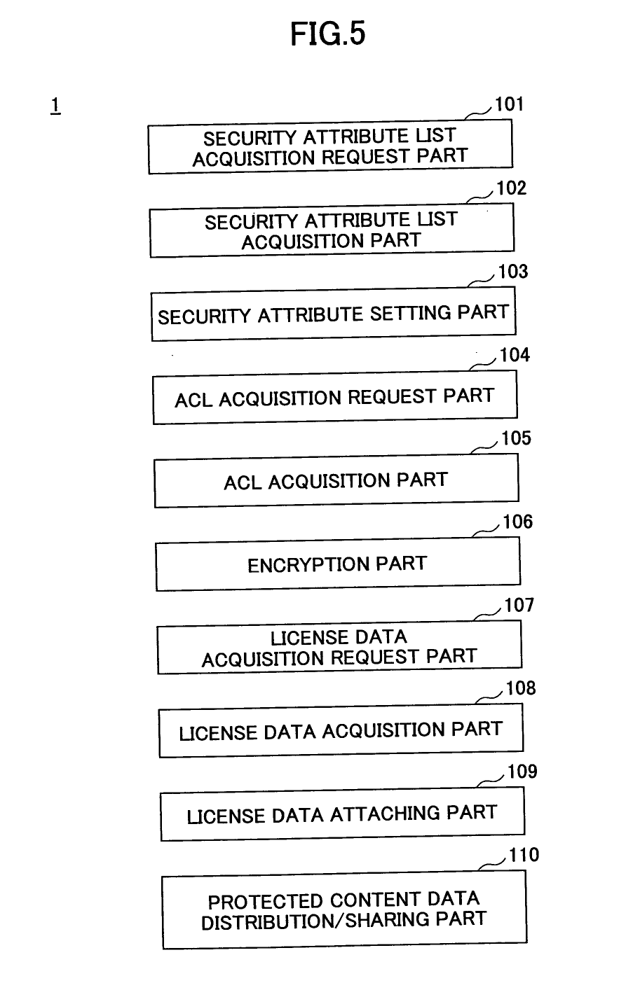

With reference to FIG. 5, a functional configuration of the original content creator terminal 1 is described next.

As shown, the original content creator terminal 1 includes a security attribute list acquisition request part 101, a security attribute list acquisition part 102, a security attribute setting part 103, an ACL acquisition request part 104, an ACL acquisition part 105, an encryption part 106, a license data acquisition request part 107, a license data acquisition part 108, a license data attaching part 109 and a protected content data distribution/sharing part 110.

The security attribute list acquisition request part 101 requests a security attribute list from the policy server 2 or such.

The security attribute list acquisition part 102 acquires the security attribute list transmitted from the policy server 2 or such in response to the security attribute list acquisition request.

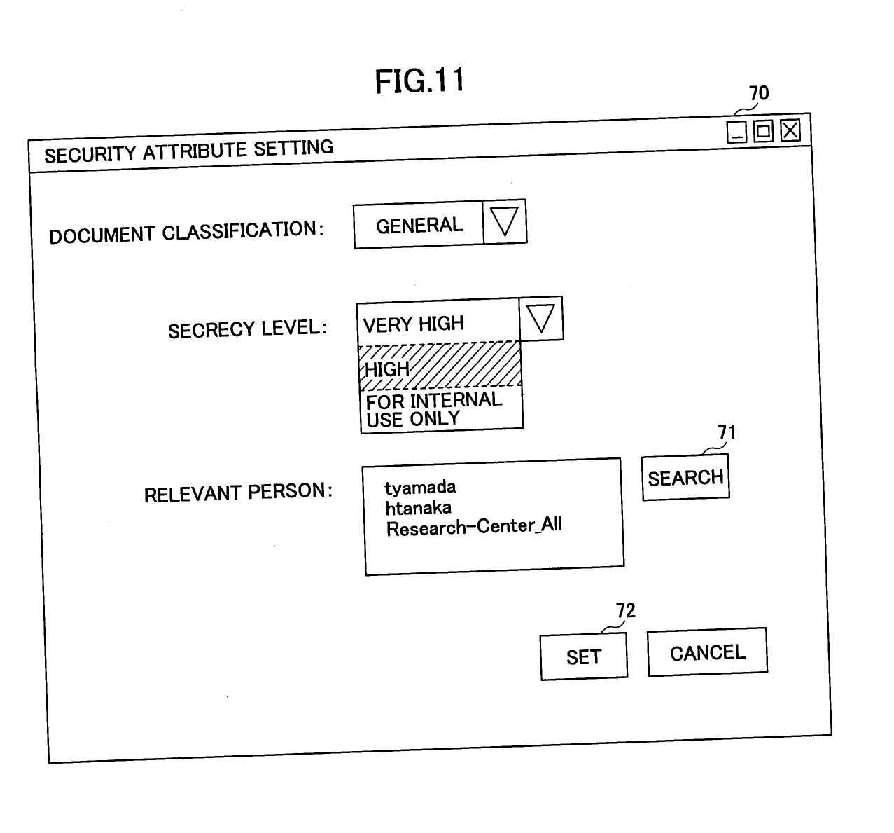

The security attribute setting part 103 carries out security attribute setting processing, and, for example, displays a security attribute setting page on the display device for setting security attributes in response to an input or a selection by a user for a security attribute displayed on the security attribute setting page displayed on the display device as shown in FIG. 11, described later.

The ACL acquisition request part 104 sends a security attribute to the policy server 2 for example, and requests an ACL therefrom.

The ACL acquisition part 105 acquires the ACL transmitted from the policy server 2 for example, in response to the ACL acquisition request.

The encryption part 106 encrypts original content data with the use of an encryption key or such.

The license data acquisition request part 107 requests license data from the right management server 3 for example by sending thereto the encryption key used for encrypting the original content data and/or an ACL.

The license data acquisition part 108 acquires the license data from the right management server 3 for example, transmitted therefrom according to the license data acquisition request.

The license data attaching part 109 attaches the license data to the encrypted original content data.

The protected content data distribution/sharing part 110 distributes the encrypted original content data having the license data attached thereto (protected content data), to the reader terminal 4, or shares the same with the reader terminal 4.

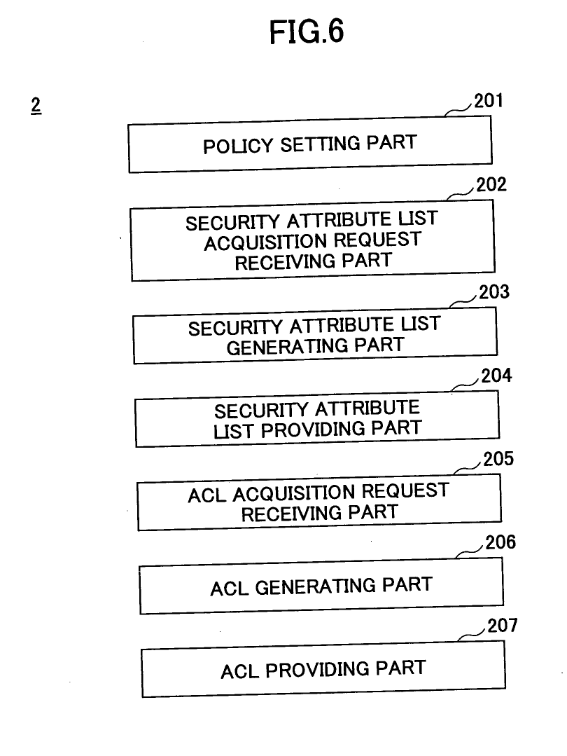

With reference to FIG. 6, a functional configuration of the policy server 2 is described next.

As shown, the policy server 2 includes a policy setting part 201, a security attribute list acquisition request receiving part 202, a security attribute list generating part 203, a security attribute list providing part 204, an ACL acquisition request receiving part 205, an ACL generating part 206 and an ACL providing part 207.

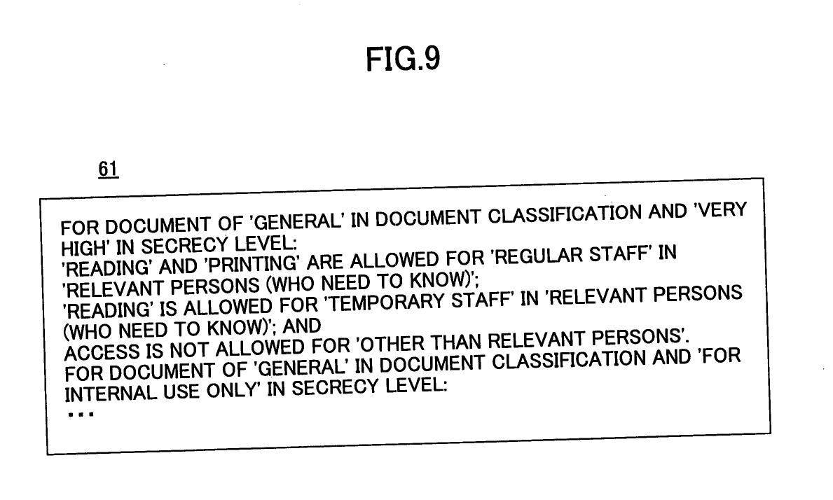

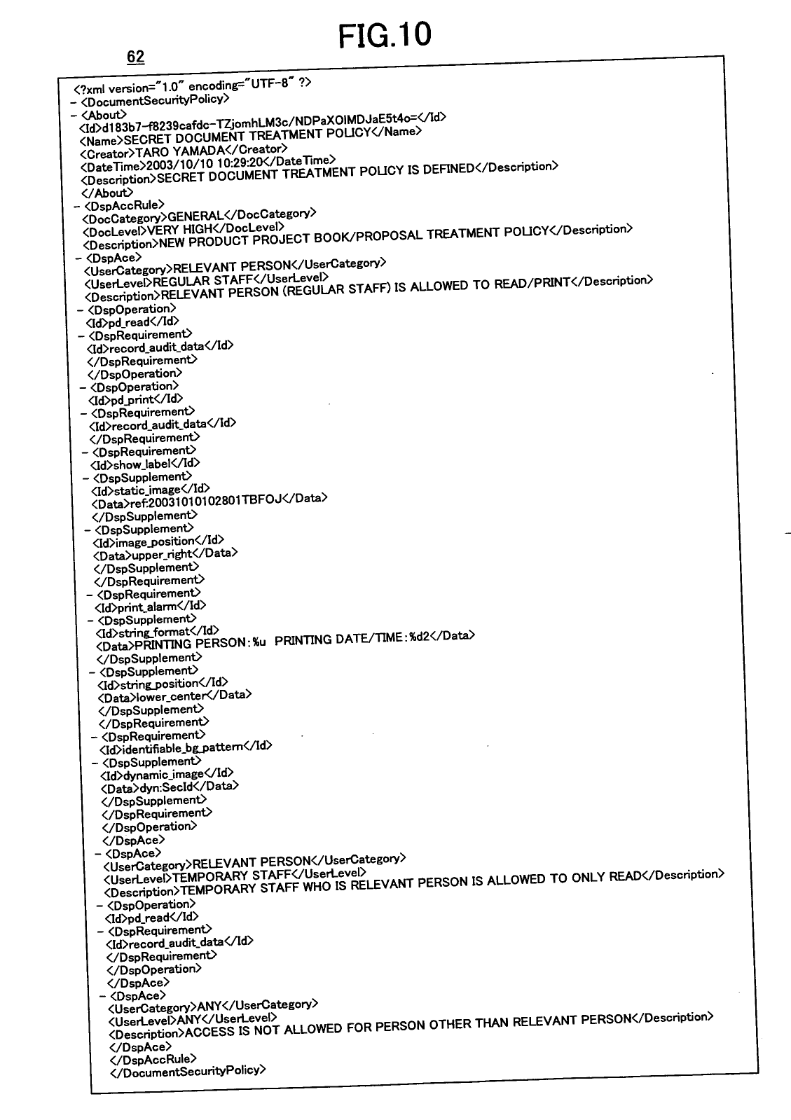

The policy setting part 201 responds to a request from a manager or such, sets a policy, and holds it in a form of a policy file or such. One example of the security policy of an organization is shown in FIG. 9 described later. One example of the policy file is shown in FIG. 10 described later.

The security attribute list acquisition request receiving part 202 receives a security attribute list acquisition request from the original content creator terminal 1 for example.

The security attribute list generating part 203 responds to the security attribute list acquisition request to generate (or acquire) a security attribute list.

The security attribute list providing part 204 provides the security attribute list, generated (or acquired) in response to the security list acquisition request, to the original content creator terminal 1 for example.

The ACL acquisition request receiving part 205 receives an ACL acquisition request to which a security attribute is attached, from the original content creator terminal 1 for example.

The ACL generating part 206 generates an ACL based on the security attribute or so included in the ACL acquisition request.

The ACL providing part 207 provides the ACL generated in response to the ACL acquisition request, to the original content creator terminal 1 for example.

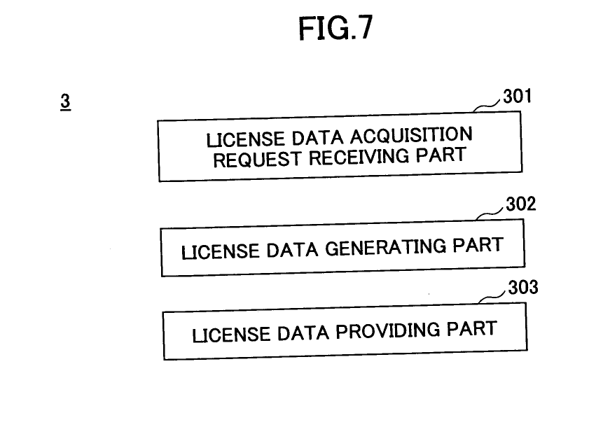

With reference to FIG. 7, a functional configuration of the right management server 3 is described next.

As shown, the right management server 3 includes a license data acquisition request receiving part 301, a license data generating part 302 and a license data providing part 303.

The license data acquisition request receiving part 301 receives a license data acquisition request including and an encryption key and an ACL, from the original content creator terminal 1, for example.

The license data generating part 302 generates license data based on the encryption key and the ACL included in the license data acquisition request.

The license data providing part 303 provides the license data generated in response to the license data acquisition request, to the original content creator terminal 1 for example, which is the request source.

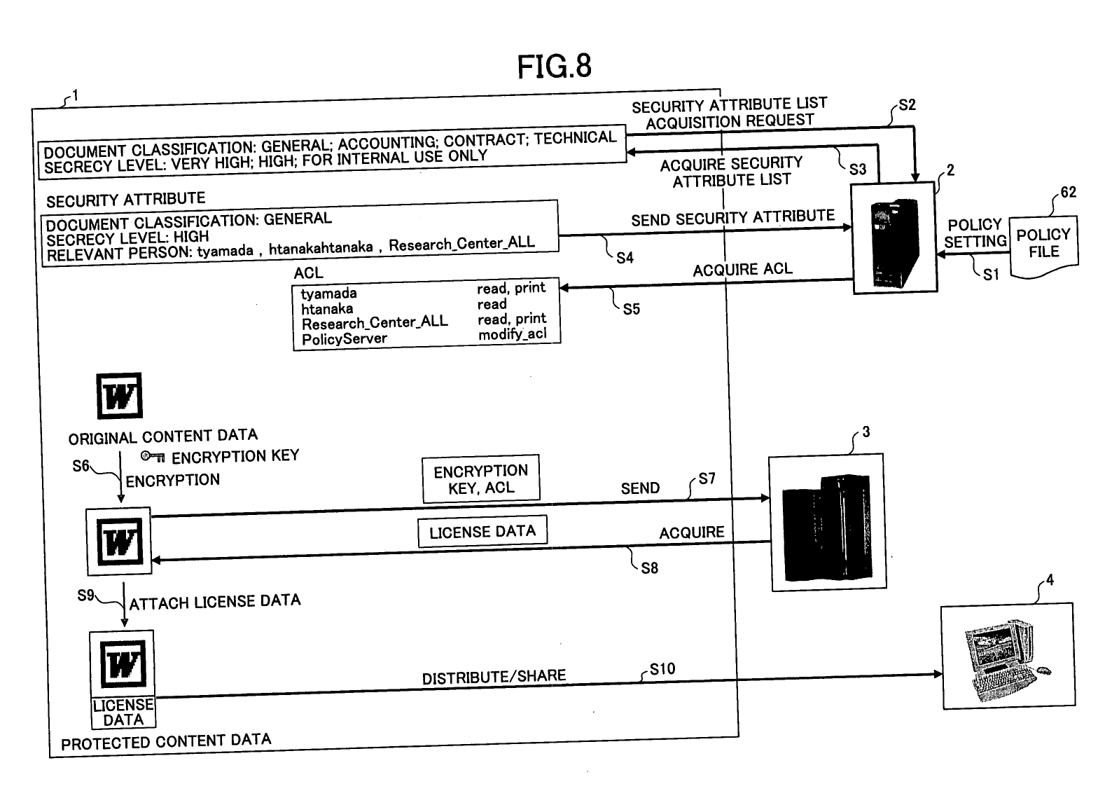

With reference to FIG. 8, one example of document ACL setting processing according to the first embodiment is described now. It is noted that a mark of an alphabet “W” enclosed by a square is a trademark of Microsoft Word.

First, in Step S1, the policy setting part 201 of the policy server 2 holds a security policy 61 of an organization set by a manager of the security server 2, in an HDD 29 or such in a form of a policy file 62.

FIG. 9 shows one example of the organization's security policy 61. As shown, as the organization's security policy, operations allowable according to a document classification and a security level are defined.

FIG. 10 shows one example of a policy file 62 held by the policy server 2.

For example, when the organization's security policy 62 as shown in FIG. 9 is input by a manager or such of the policy server 2 with the use of a GUI or such displayed on the display device of the policy server 2, the policy setting part 201 of the policy server 2 generates the policy file 62 as shown in FIG. 10, and stores it in the HDD 29 or such.

A description format of the policy file 62 may be an XML (extensible markup language) format, or may be an XACML (extensible access control markup language).

In Step S2 of FIG. 8, the security attribute list acquisition request part 101 of the original content creator terminal 1 requests a security attribute list from the policy server 2 or such. For example, the security attribute list acquisition request part 101 of the original content creator terminal 1 transmits a SOAP request for reading a getSecurityLabels ( ) method of the policy server 2, to the policy server 2 as the security attribute list acquisition request. It is noted that I/F of the getSecurityLabels ( ) method is:

String [ ] getSecurityLabels (String type); and, as a result of “DOC_CATEGORY” being designated in ‘type’, those designateable as a document classification are returned as a table of String. As a result of “DOC_SENSITIVITY” being designated in ‘type’, those designateable as a secrecy level are returned as a table of String.

The security attribute list acquisition request part 101 transmits a SOAP request in which ‘type’ is included, to the policy server 2.

The security attribute list acquisition request receiving part 202 of the policy server 2 receives the security attribute list acquisition request (the SOAP request) from the original content creator terminal 1 or such.

The security attribute list generating part 203 of the policy server 2 responds to the security attribute list acquisition request, to generate (or acquire) a security attribute list by executing the getSecurityLabels ( ) method, for example.

In Step S3 of FIG. 8, the security attribute list providing part 204 provides the security attribute list, thus generated (or acquired) in response to the security attitude list acquisition request, to the original content creator terminal 1. For example, the security attribute list providing part 204 acquires the returned value of the getSecurityLabels ( ) method as the security attribute list, includes it in a SOAP response, and transmits it to the original content creator terminal 1.

The security attribute list acquisition part 102 of the original content creator terminal 1 acquires the security attribute list transmitted from the policy server 2 in response to the security attribute list acquisition request. For example, the security attribute list acquisition part 102 receives the SOAP response including the security attributes list from the policy server 2.

The security attribute setting part 103 in the original content creator terminal 1 displays a security attribute setting page 70 including the security attribute list, and requests a user to set a security attribute.

FIG. 11 shows one example of the security attribute setting page 70.

As shown, the security attribute setting part 103 displays the security attitude setting page 70 for setting, as a security attribute, a document classification, a secrecy level, a relevant parson, and so forth, on the display device or such. A configuration may be provided such that, when the user clicks a search button 71, an inquiry may be sent to a directory server or such with the use of LDAP (lightweight directory access protocol) or such, for searching for a user or a group.

When a security attributes is selected as shown in the security attribute setting page 70 and a set button 72 is clicked, the security attribute setting part 103 of the original content creator terminal 1 sets (stores) the thus-selected security attribute in the RAM 16, the HDD 19, or such.

In Step S4 of FIG. 8, the ACL acquisition request part 104 of the original content creator terminal 1 transmits an ACL acquisition request including the thus-set security attribute, to the policy server 2. For example, the ACL acquisition request part 104 of the original content creator terminal 1 transmits a SOAP request for reading a getACL ( ) method of the policy server 2 to the policy server 2 as the ACL acquisition request. It is noted that I/F of the getACL ( ) method is:
ACE [ ] getACL (String category, String level, String [ ] principalIds);
and, when a document classification is designed in ‘category’, a secrecy level is designated in ‘level’, and a user ID or a group ID of a relevant person is designated in ‘principalIds’, for example, an access control list (ACL) is returned.

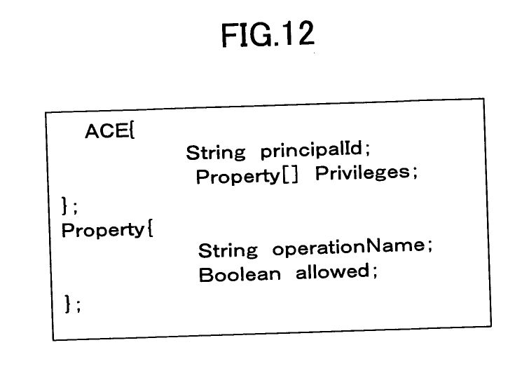

FIG. 12 shows one example of a structure of ACE (access control element).

In principalId shown in FIG. 12, a user ID or a group ID is stored, an operation name such as “read”, “print” or such is stored in operationName, and ‘true’ is stored in ‘allowed’ when the operation is allowed.

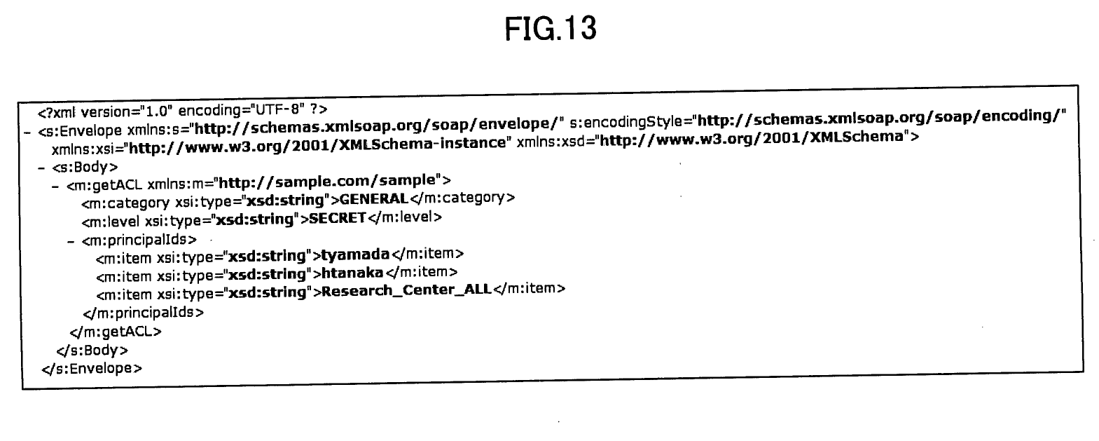

FIG. 13 shows one example of a SOAP request for reading the getACL ( ) method.

As shown in FIG. 13, in the SOAP request, a method name (getACL) is stored in a tag, as an argument of the method, a document classification, a secrecy level, a user ID and/or a group ID is stored in each tag.

In FIG. 8, the ACL acquisition request receiving part 205 of the policy server 2 receives the ACL acquisition request (SOAP request shown in FIG. 13) from the original content creator terminal 1 or such.

The ACL generating part 206 of the policy server 2 generates an ACL by executing the getACL ( ) method, based on the security attribute or such included in the ACL acquisition request. In the getACL ( ) method, an inquiry is made to the directory server with the use of LDAP or such as to whether or not hyamada, htanaka, Reseach_Center_ALL or such which is a user ID/group ID received as the argument correspond to a regular staff. When he/she is a regular staff, ‘read’ and ‘print’ are stored in operationName of the ACE according to the policy file 62 or such. On the other hand, when he/she is a temporary staff, only ‘read’ is stored in operationName of the ACE according to the policy file 62 or such.

In order to allow such a difference in a processing manner depending on whether he/she is a regular staff or a temporary staff, such information should be previously managed for determining whether or not he/she is a regular staff or a temporary staff, when the user and the group is managed in the directory server or such. A post or such may be managed as an attribute value of a decretory entry, or, such a management manner may be made in which a user or a group belonging to an OU (organization unit) named REGULAR is a regular staff, while he/she belonging to an OU named TEMPORARY is a temporary staff, for example, in the directory server.

The policy server 2 should determine whether or not each user or group corresponds to a regular staff according to a management manner in the directory server.

In Step S5 of FIG. 8, the ACL providing part 207 of the policy server 2 provides the ACL generated in response to the ACL acquisition request, to the original content creator terminal 1. For example, the ACL providing part 207 of the policy server 2 acquires a returned value of the getACL ( ) method, includes it in a SOAP response, and transmits it to the original content creator terminal 1.

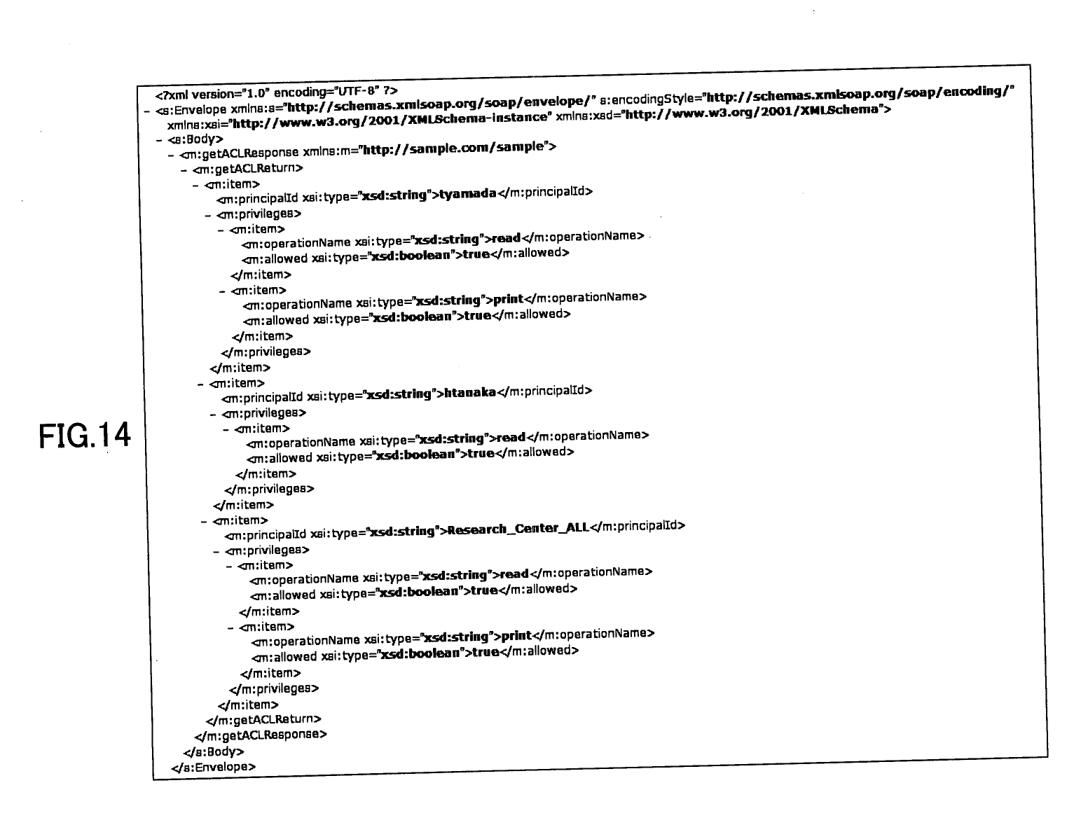

FIG. 14 shows one example of a SOAP response including the returned value of the getACL ( ) method as ACL.

As shown in FIG. 14, in the SOAP response, a plurality of the above-mentioned ACE (as a list) are included.

In FIG. 8, the ACL acquisition part 105 of the original content creator terminal 1 acquires the ACL transmitted from the policy server 2 in response to the ACL acquisition request. For example, the ACL acquisition part 105 receives the SOAP response including the ACL from the policy server 2.

In Step S6, the encryption part 106 of the original content creator terminal 1 encrypts the original content data with an encryption key or such.

In Step S7, the license data acquisition request part 107 of the original content creator terminal 1 sends the encryption key used for encrypting the original content data and/or the ACL acquired as mentioned above, to the right management server 3, and requests license data therefrom.

The license data acquisition request receiving part 301 of the right management server 3 receives the license data acquisition request from the original content creator terminal 1.

The license data generating part 302 of the right management server 3 responds to the license data acquisition request, and generates license data based on the encryption key and/or the ACL included in the acquisition request.

In Step S8, the license data providing part 303 of the right management server 3 provides the license data generated in response to the license data acquisition request, to the original content creator terminal 1.

The license data acquisition part 108 in the original content creator terminal 1 receives the license data transmitted from the right management server 3 or such in response to the ACL acquisition request.

In Step S9, the license data attaching part 109 of the original content creator terminal 1 attaches the license data to the encrypted original content data. Thus, the protected content data is acquired.

Then, in Step S10, the protected content data distribution/sharing part 110 of the original content creator terminal 1 distributes or shares the protected content data to or with the reader terminal 4.

By means of the processing shown in FIG. 8 described above, the ACL can be attached to the document content data according to the organization's security policy.

In each of Steps S2, S3, S4, S5 and so forth of FIG. 8, as a result of communication being carried out with the use of SOAP as described above, communication can be carried out between the original content creator terminal 1 and the policy server 2 without regard to an OS or a program language applied there.

Further, in Step S7 or S8, communication may be carried out also with the use of SOAP.

A second embodiment of the present invention is described now.

In the first embodiment described above, the original content creator terminal 1 acquires an ACL from the policy server 2, and stores it in the HDD 19 or such. However, in this configuration, the original content creator may freely change the ACL, or a person pretending to be the original content creator may freely change the ACL.

In the second embodiment, an ACL is held and managed in the policy server 2 for avoiding such a situation. Then, as a result of the policy server 2 giving only a manager or such a change right for the ACL, the original content creator or a person pretending to be the original content creator cannot freely change the ACL. For the propose of avoiding an illegal change of the ACL by a person pretending to be the manage of the policy server 2 for example, user authentication data in the policy server 2 should be updated frequently, for example. Hereinbelow, points different from the first embodiment are mainly described.

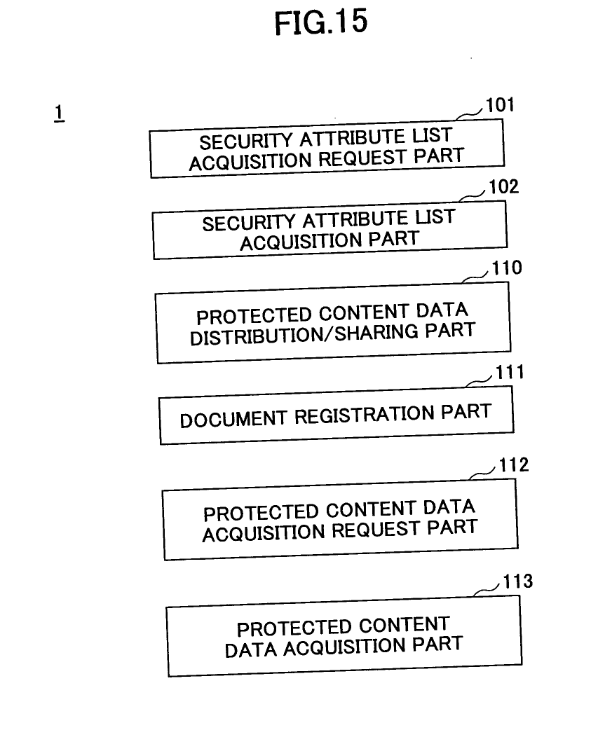

FIG. 15 shows one example of a functional configuration of the original content creator terminal 1 for the second embodiment.

As shown in FIG. 15, the original content creator terminal 1 includes a security attribute list acquisition request part 101, a security attribute list acquisition part 102, a protected content data distribution/sharing part 110, a document registration part 111, a protected content data acquisition request part 112 and a protected content data acquisition part 113.

Functions of the security attribute list acquisition request part 101, the security attribute list acquisition part 102 and the protected content data distribution/sharing part 110 are the same as those of the first embodiment described above.

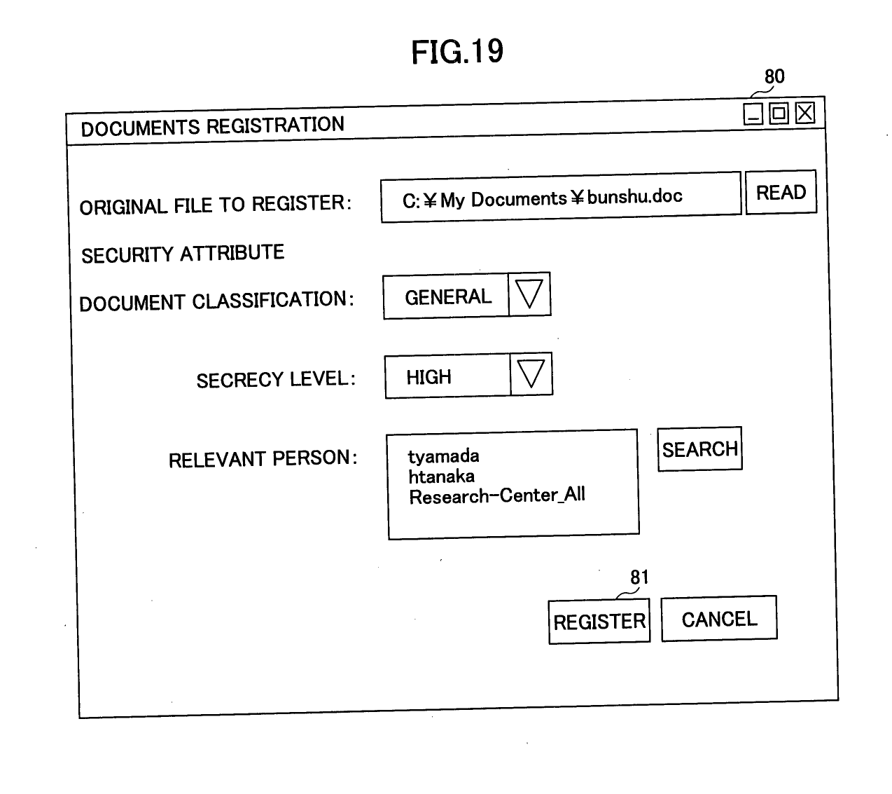

The document registration part 111 carries out document registration processing, and, for example, this part 111 displays on the display device a document registration page shown in FIG. 19 described later, or such, or registers (sets) a document and a security attitude according to the user's selection or input of the document and the security attribute on the document registration page.

The protected content data acquisition request part 112 transmits, to the policy server 2 or such for example, a protected content data acquisition request including original content data and a security attribute.

The protected content data acquisition part 113 acquires protected content data transmitted from the policy server 2 or such for example in response to the protected content data acquisition request.

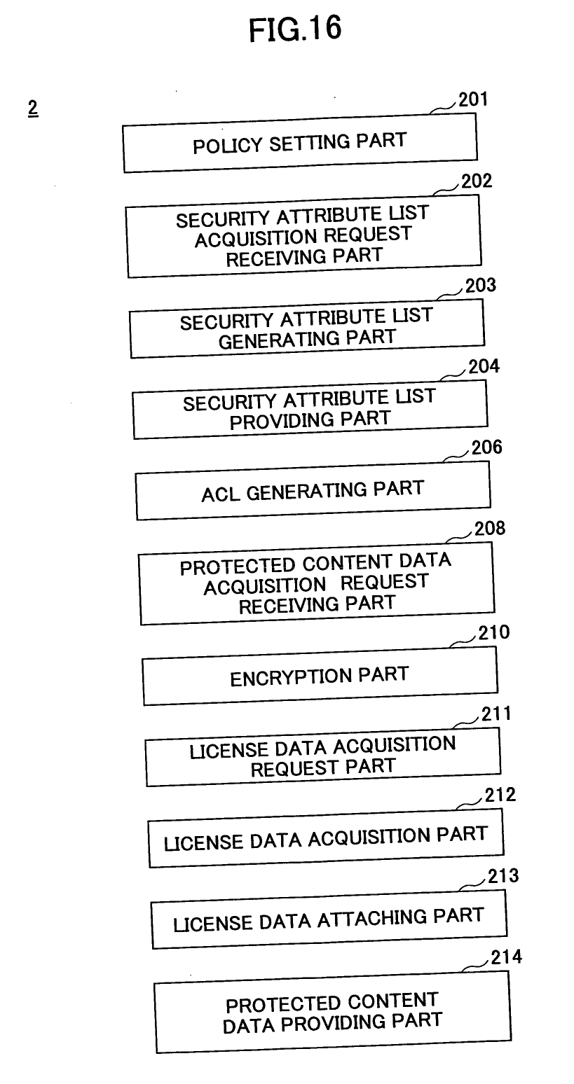

FIG. 16 shows one example of a functional configuration of the policy server 2 according to the second embodiment.

As shown in FIG. 16, the policy server 2 includes a policy setting part 201, a security attribute list acquisition request receiving part 202, a security attribute list generating part 203, a security attribute list providing part 204, an ACL generating part 206, a protected content data acquisition request receiving part 208, an encryption part 210, a license data acquisition request part 211, a license data acquisition part 212, a license data attaching part 213, and a protected content data providing part 214.

Functions of the policy setting part 201, the security attribute list acquisition request receiving part 202, the security attribute list generating part 203, the security attribute list providing part 204 and the ACL generating part 206 are the same as those of the first embodiment described above.

The protected content data acquisition request receiving part 208 receives a protected content data acquisition request from the original content creator terminal 1, for example.

The encryption part 210 encrypts original content data with the use of an encryption key. For example, the encryption part 210 encrypts original content data acquired from the original content creator terminal 1 for example, with the use of an encryption key stored in the RAM 26, the HDD 29 or such.

The license data acquisition request part 211 requests license data from the right management server 3 or such for example, by sending the encryption key used for encrypting original content data and/or the ACL.

The license data acquisition part 212 acquires license data transmitted by the right management server 3 or such for example in response to the license data acquisition request.

The license data attaching part 213 attaches the license data to the encrypted original content data.

The protected content data providing part 214 provides protected content data (the encrypted original content data having the license data attached thereto) produced in response to a protected content data acquisition request, to the original content creator terminal 1 for example.

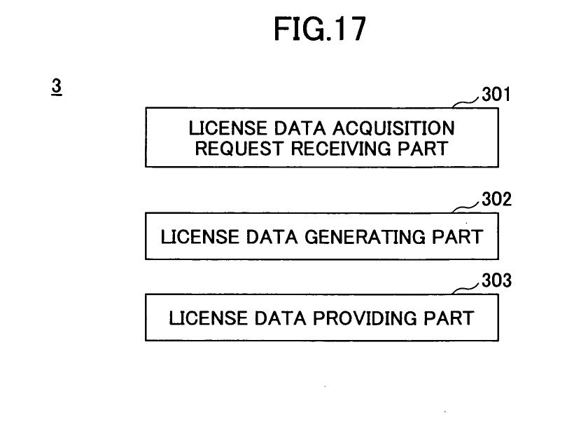

FIG. 17 shows a function configuration of the right management server 3 in the second embodiment.

As shown in FIG. 17, the right management server 3 includes a license acquisition request receiving part 301, a license data generating part 302 and a license data providing part 303. The functional configuration shown in FIG. 17 is the same as that of FIG. 7.

However, the license data acquisition request receiving part 301 of FIG. 17 receives the license data acquisition request including the encryption key and the ACL from the policy server 2.

Further, the license data providing part 303 of FIG. 17 provides the license data generated in response to the license data acquisition request, to the policy server 2 which is the request source.

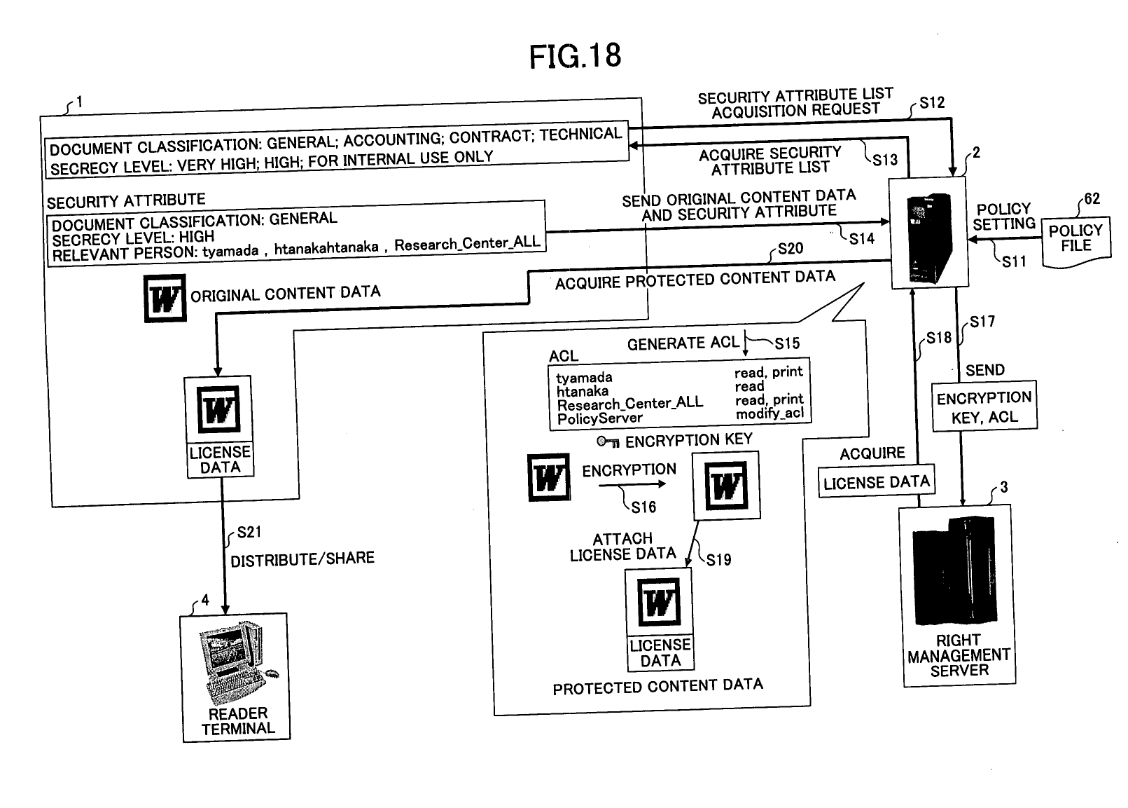

FIG. 18 shows one example of document ACL setting processing according to the second embodiment. It is noted that a mark of an alphabet “W” enclosed by a square is a trademark of Microsoft Word.

First, in Step S11, the policy setting part 201 of the policy server 2 holds an organization's security policy 61 set by a manager of the policy server 2, in the HDD 29 or such in a form of a policy file 62.

Then, in Step S12, the security attribute list acquisition request part 101 of the original content creator terminal 1 requests a scrutiny attribute list from the policy server 2 or such.

The security attribute list acquisition request receiving part 202 of the policy server 2 receives the security attribute list acquisition request (SOAP request) from the original content creator terminal 1 or such. For example, the security attribute list acquisition request part 101 of the original content creator terminal 1 transmits a SOAP request for reading a getSecurityLabels ( ) method of the policy server 2, to the policy server 2 as the security attribute list acquisition request.

The security attribute list generating part 203 of the policy server 203 responds to the security attribute list acquisition request to generate (or acquire) a security attribute list by executing the getSecurityLabels ( ) method.

In Step S13, the security attribute list providing part 204 provides the security attribute list thus generated (or acquired) in response to the security list acquisition request, to the original content creator terminal 1. For example, the security attribute list providing part 204 includes a returned value of the getSecurityLabels ( ) method in a SOAP response, and transmits the same to the original content creator terminal 1.

The security attribute list acquisition part 102 of the original content creator terminal 1 acquires the security attribute list transmitted in response to the security attribute list acquisition request from the policy server 2. For example, the security attribute list acquisition part 102 receives a SOAP response including the security attribute list from the policy server 2.

The document registration part 111 of the original content creator terminal 1 displays a document management page 80 such as that including the security attribute list on the display device, and requests a user to register a document and set a security attribute.

FIG. 19 shows one example of the document management page 80.

As shown in FIG. 19, the document registration part 111 displays the document registration page 80 for registering or setting an original file and a security attribute, on the display device.

When original contents to register are selected, a security attribute is selected and a registration button 81 is clicked or such as shown on the document registration page 80, the document registration part 111 sets (stores) the selected security attribute and registers (stores) the original file in the RAM 16, the HDD 19, or such.

In Step S14 of FIG. 18, the protected content data acquisition request part 112 of the original content creator terminal 1 transmits a protected content data acquisition request including the original content data and the security attribute to the policy server 2. For example, the protected content data acquisition request part 112 of the original content creator terminal 1 transmits a SOAP request for reading a protectDocument ( ) method of the policy server 2 to the policy server 2 as the protected content data acquisition request. It is noted that I/F of the protectDocument ( ) method is:
byte [ ] protectDocument (String category, String level, String [ ] principalIds, byte [ ] documentData);
and, by designating a document classification in ‘category’, a secrecy level in ‘level’, a user ID or a group ID of a relevant person in ‘principalIds’, and original content data in ‘documentData’, protected content data is returned.

The protected content data acquisition request receiving part 208 of the policy server 2b receives a protected content data acquisition request (a SOAP request for reading the protectDocument ( ) method) from the original content creator terminal 1.

In Step S15, the ACL generating part 206 of the policy server 2 executes the protectDocument ( ) method based on the security attribute or such included in the protected content data acquisition request, and generates an ACL. Another configuration may be provided in which the protectDocument ( ) method executes the above-described getACL ( ) method, and generates the ACL.

In Step S16, the encryption part 210 of the policy server 2 is called by the protectDocument ( ) method, for example, and encrypts the original content data included in the protected content data acquisition request, with the use or an encryption key or such.

Then, in Step S17, the license data acquisition request part 211 of the policy server 2 is called by the protectDocument ( ) method, for example, and requests license data from the right management server 3 or such by sending the encryption key used for encrypting the original content data and/or the generated ACL.

The license data acquisition request receiving part 301 of the right management server 3 receives the license data acquisition request from the policy server 2.

The license data generating part 302 of the right management server 3 responds to the license data acquisition request, and generates license data based on the encryption key and/or the ACL included in the license data acquisition request.

In Step S18, the license data providing part 303 of the right management server 3 provides the license data generated in response to the license data acquisition request, to the policy server 2.

The license data acquisition part 212 of the policy server 2 is called by the protectDocument ( ) method, for exempla, and acquires the license data transmitted in response to the license data acquisition request from the right management server 3 or such.

In Step S19, the license data attaching part 213 of the policy server 2 is called by the protectDocument ( ) method, for example, and attaches the license data to the encrypted original content data.

Then in Step S20, the protected content data providing part 214 of the policy server 2 is called by the protectDocument ( ) method, for example, and provides the protected content data (the encrypted original content data having the license data attached thereto) produced in response to the protected content data acquisition request, to the original content creator terminal 1. For example, the protected content data providing part 214 of the policy server 2 includes a returned value of the protectDocument ( ) method in a SOAP response as the protected content data, and transmits the same to the original content creator terminal 1.

The protected content data acquisition part 113 of the original content creator terminal 1 acquires the protected content data transmitted in response to the protected content data acquisition request from the policy server 2 or such. For example, the protected content data acquisition part 113 of the original content creator terminal 1 receives the SOAP response including the protected content data, from the policy server 2.

In Step S21, the protected content data distribution/sharing part 110 of the original content creator terminal 1 distributes the protected content data to the reader terminal 4 or shares the same with the reader terminal 4.

By carrying out the processing shown in FIG. 18, illegal change of an ACL can be effectively avoided, while the ACL can be attached to document content data according to an organization's security policy.

In Steps S12, S13, S14, S20 or such of FIG. 18, communication can be carried out between the original content creator terminal 1 and the policy server 2 without regard to an OS or a program language applied there, by applying SOAP mentioned above.

Also in Step S17 or S18, communication may be carried out with the use of SOAP.

A third embodiment of the present invention is described next.

In the first embodiment described above, for example in the original content creator terminal 1, various sorts of processing is carried out, i.e., acquiring an ACL, encryption of original content data, producing protected content data, as well as creating original content. However, processing may be shared, i.e., the original content creator terminal 1 may carry out minimum necessary processing, i.e., creating original content data, security attribute setting or such, while acquiring an ACL, encryption of original content data, or such may be carried out by a document management server 5 or such in a lump.

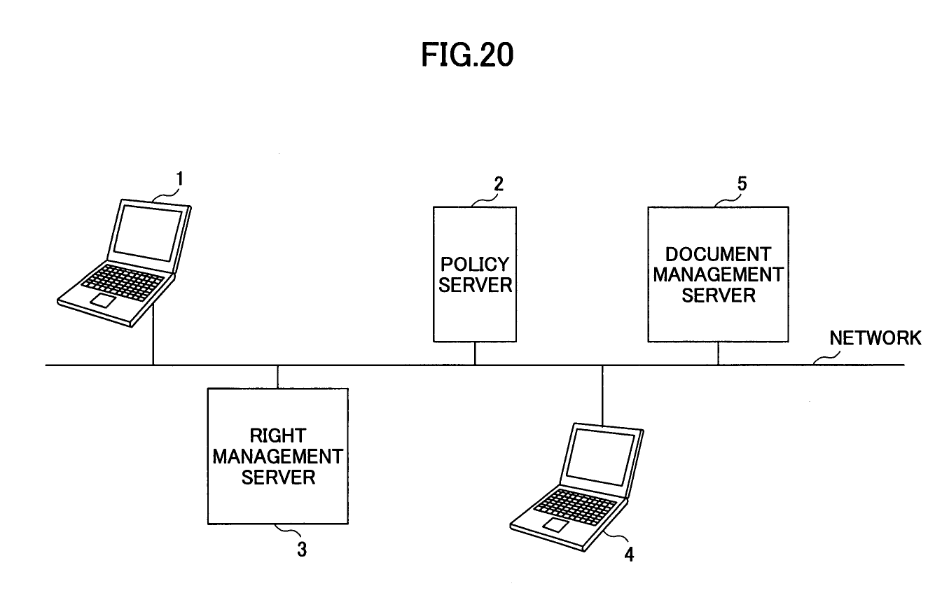

FIG. 20 shows a document ACL attaching system according to the third embodiment of the present invention.

In this system, as shown in FIG. 20, an original content creator terminal 1, a policy server 2, a right management server 3, a reader terminal 4 and a document management server 5 are connected via a communication network.

The original content creator terminal 1 is used for creating original content data. The policy server 2 is used for holding a policy set by a manager or such in a form of a policy file. The right management server 3 is used for managing rights such as an access right, access time limit and so forth for a document. The reader terminal 4 is used for acquiring, reading, or so, of protected content data, by a reader. A document management server 5 is used for managing a document, and, has functions of encrypting a document (original content data), producing protected content data by attaching license data to the encrypted original content data, and managing it.

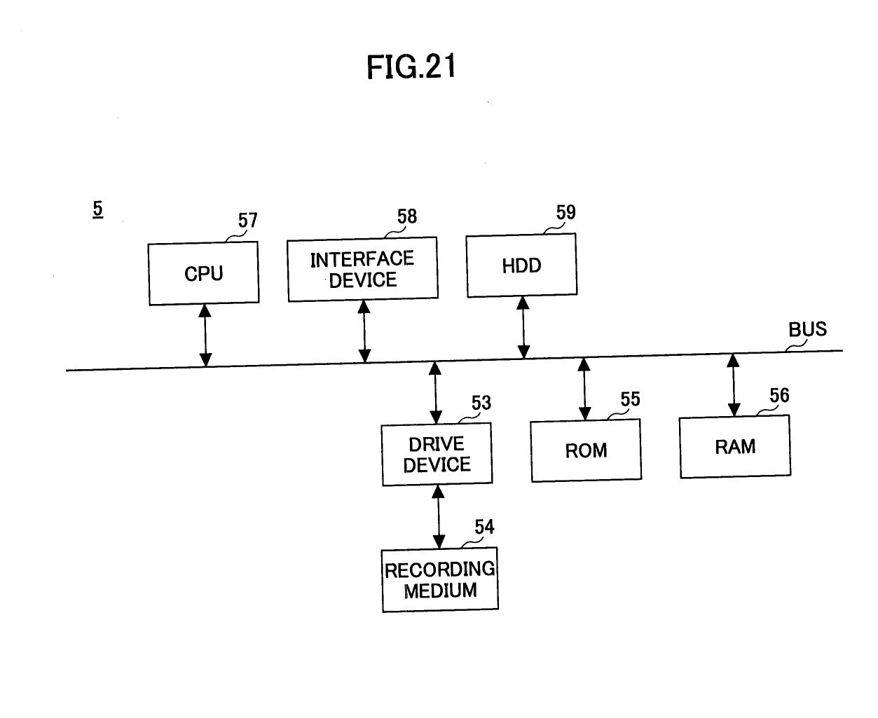

With reference to FIG. 21, a hardware configuration of the document management server 5 is described.

As shown in FIG. 21, the document management server 5 includes a drive device 53, a ROM 55, a RAM 56, a CPU 57, an interface part 58, and a HDD 59, which are mutually connected by a bus.

An interface device 58 connects the document management server 5 with the communication network or such.

A program corresponding to each function of the document management server 5 described later is provided to the document management server 5 via a recording medium 54 such as a CD-ROM or such, or, may be downloaded to the document management server 5 via the communication network. The recording medium is set in the drive device 53, and the program is installed in the HDD 59 via the drive device 53 from the recording medium.

The ROM 55 is used to store data. The RAM 56 is used to store the program read out from the HDD 59 upon starting up of the document management server 5, for example. The CPU 57 executes processing according to the program stored in the RAM 56.

The HDD 59 is used to store programs, data, a security attribute list, security attributes, original content data, an encryption key, protected content data or such.

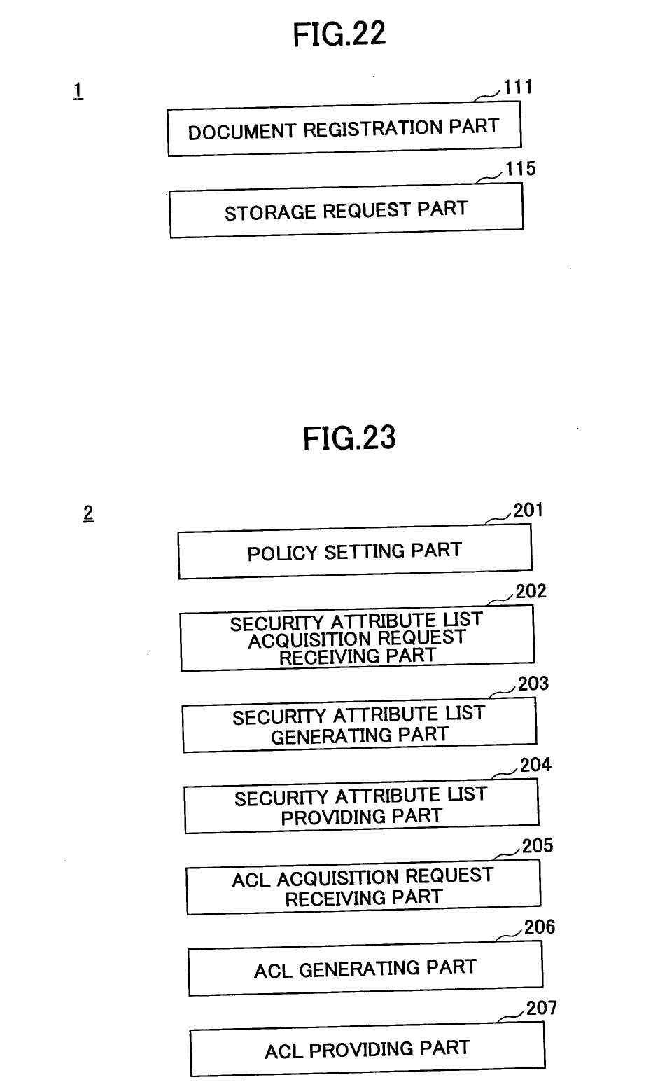

FIG. 22 shows one example of a functional configuration of the original content creator terminal 1 according to the third embodiment.

As shown in FIG. 22, the original content creator terminal 1 includes a document registration part 111 and a storage request part 115.

The document registration part 111 carries out document registration processing, reads a security attribute list of the document management server 5, displays a document management page as shown in FIG. 19, or registers (sets) a document and a security attribute in response to the user's selection or the user's input of the document and the security attribute on the document management page.

The storage request part 115 requests the document management server 5 to store the document and the security attribute thus registered (set) on the document management page as shown in FIG. 19.

FIG. 23 shows a functional configuration of the policy server 2 according to the third embodiment.

As shown in FIG. 23, the policy server 2 includes a policy setting part 201, a security attribute list acquisition request receiving part 202, a security attribute list generating part 203, a security attribute list providing part 204, an ACL acquisition request receiving part 205, an ACL generating part 206 and an ACL providing part 207. The functional configuration of FIG. 23 is the same as that of FIG. 6.

However, the security attribute list acquisition request receiving part 202 shown in FIG. 23 receives a security list acquisition request from the document management server 5 for example.

Further, the security attribute list providing part 204 shown in FIG. 23 provides a security attribute list generated (or acquired) in response to a security attribute list acquisition request, to the document management sever 5 for example.

Further, the ACL acquisition request receiving part 205 shown in FIG. 23 receives a an ACL acquisition request having a security attribute attached thereto, from the document management server 5, for example.

The ACL providing part 207 shown in FIG. 23 provides an ACL generated in response to an ACL acquisition request, to the document management server 5, which is a request source, for example.

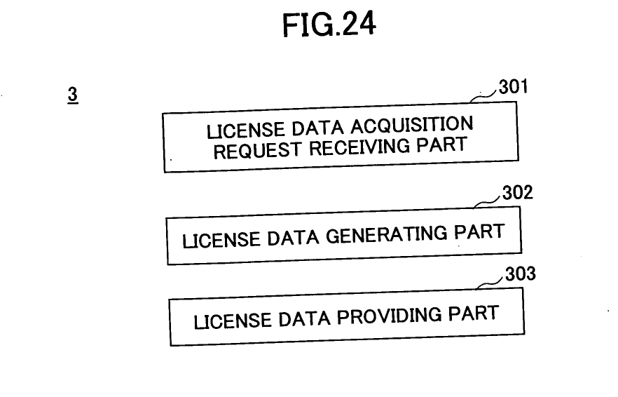

A functional configuration of the right management server 3 according to the third embodiment is described next with reference to FIG. 24.

As shown in FIG. 24, the right management server 3 includes a license data acquisition request receiving part 301, a license data generating part 302 and a license data providing part 303. The functional configuration shown in FIG. 24 is the same as that of FIG. 7 or 17.

However, the license data acquisition request receiving part 301 shown in FIG. 24 receives a license data acquisition request including an encryption key and an ACL from the document management server 5.

The license data providing part 303 shown in FIG. 24 provides license data generated in response to a license data acquisition request to the document management server 5, which is the request source.

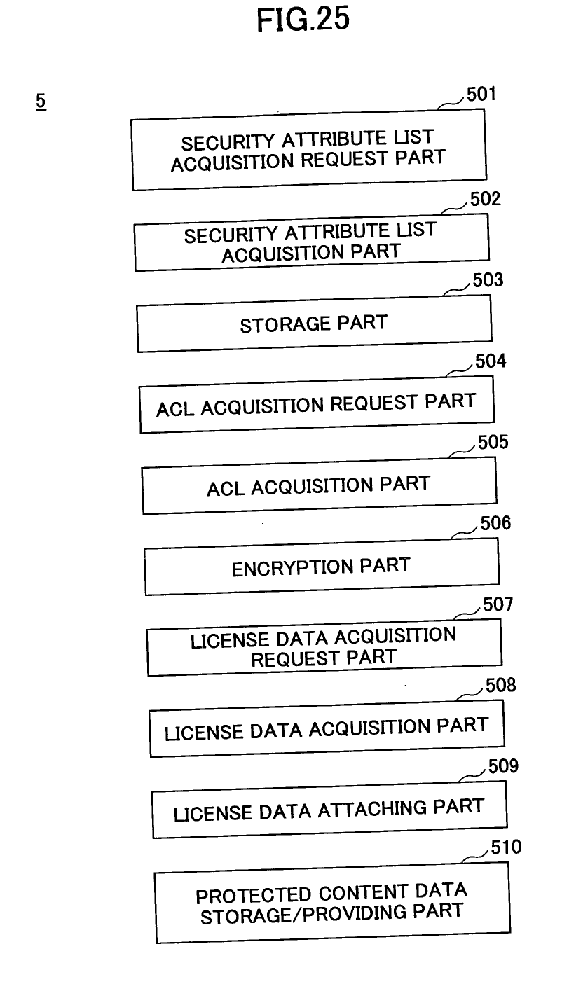

FIG. 25 shows a functional configuration of the document management server 5.

As shown in FIG. 25, the document management server 5 includes a security attribute list acquisition request part 501, a security attribute list acquisition part 502, a storage part 503, an ACL acquisition request part 504, an ACL acquisition part 505, an encryption part 506, a license data acquisition request part 507, a license data acquisition part 508, a license data attaching part 509 and a protected content data storage/providing part 510.

The security attribute list acquisition request part 501 requests a security attribute list from the policy server 2 or such.

The security attribute list acquisition part 502 acquires the security attribute list transmitted from the policy server 2 or such in response to the security attribute list acquisition request.

The storage part 503 responds to a storage request from the original content creator terminal 1, and stores a document and a security attribute in the RAM 56, the HDD 59 or such.

The ACL acquisition request part 504 sends a security attribute to the policy server 2 for example, and requests an ACL therefrom.

The ACL acquisition part 505 acquires an ACL transmitted from the policy server 2 for example, in response to the ACL acquisition request.

The encryption part 506 encrypts original content data with the use of an encryption key or such.

The license data acquisition request part 507 requests license data from the right management server 3 for example by sending thereto the encryption key used for encrypting the original content data and/or the ACL.

The license data acquisition part 508 acquires the license data from the right management server 3 for example, transmitted therefrom in response to the license data acquisition request.

The license data attaching part 509 attaches the license data to the encrypted original content data.

The protected content data storage/providing part 510 stores the encrypted original content data having the license data attached thereto (protected content data), or provides the same to the reader terminal 4 (or making the same accessible by the reader terminal 4).

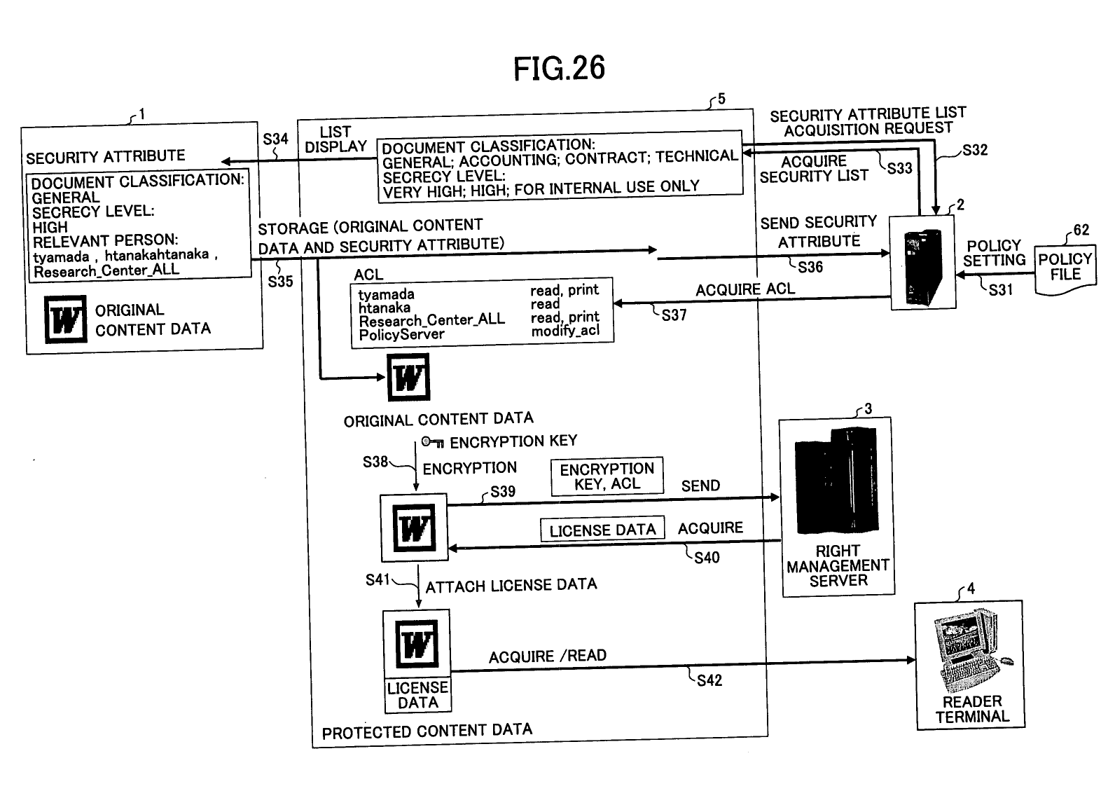

With reference to FIG. 26, one example of document ACL setting processing according to the third embodiment is described now. It is noted that a mark of an alphabet “W” enclosed by a square is a trademark of Microsoft Word.

First, in Step S31, the policy setting part 201 of the policy server 2 holds a security policy 61 of an organization set by a manager of the security server 2, in the HDD 29 or such in a form of a policy file 62.

In Step S32, the security attribute list acquisition request part 501 of the document management server 5 requests a security attribute list from the policy server 2 or such. For example, the security attribute list acquisition request part 501 of the document management server 5 transmits a SOAP request for reading a getSecurityLabels ( ) method of the policy server 2 to the policy server 2 as the security attribute list acquisition request.

The security attribute list acquisition request receiving part 202 of the policy server 2 receives the security attribute list acquisition request (SOAP request) from the document management server 5.

The security attribute list generating part 203 of the policy server 2 responds to the security attribute list acquisition request, to generate (or acquire) a security attribute list by executing the getSecurityLabels ( ) method, for example.

In Step S33, the security attribute list providing part 204 provides the security attribute list, thus generated (or acquired) in response to the security attitude list acquisition request, to the document management server 5. For example, the security attribute list providing part 204 acquires the returned value of the getSecurityLabels ( ) method as the security attribute list, includes it in a SOAP response, and transmits it to the document management server 5.

The security attribute list acquisition part 502 of the document management server 5 acquires the security attribute list transmitted from the policy server 2 in response to the security attribute list acquisition request. For example, the security attribute list acquisition part 502 receives the SOAP response including the security attribute list from the policy server 2.

In Step S34, the document registration part 111 of the original content creator terminal 1 reads the security attribute list of the document management server 5, and displays a security attribute setting page 80 including the security attribute list on the display device, and requests a user to register a document and to set a security attribute.

In Step S35, the storage request part 115 of the original content creator terminal 1 requests the document management server 5 to store a document and a security attribute thus registered (set) on the document registration page such as that shown in FIG. 19.

The storage part 503 of the document management server 5 responds to the storage request from the original content creator terminal 1, and stores the document and the security attribute in the RAM 56, the HDD 59 or such.

In Step S36, the ACL acquisition request part 504 of the document management server 5 transmits an ACL acquisition request including the security attribute, to the policy server 2. For example, the ACL acquisition request part 504 of the document management server 5 transmits a SOAP request for reading a getACL ( ) method of the policy server 2 to the policy server 2 as the ACL acquisition request.

The ACL acquisition request receiving part 205 of the policy server 2 receives the ACL acquisition request (SOAP request shown in FIG. 13) from the document management server 5.

The ACL generating part 206 of the policy server 2 generates an ACL by executing the getACL ( ) method, based on the security attribute or such included in the ACL acquisition request.

In Step S37, the ACL providing part 207 of the policy server 2 provides the ACL generated in response to the ACL acquisition request, to the document management server 5. For example, the ACL providing part 207 of the policy server 2 acquires a returned value of the getACL ( ) method, includes it in a SOAP response, and transmits it to the document management server 5.

The ACL acquisition part 505 of the document management server 5 acquires the ACL transmitted from the policy server 2 in response to the ACL acquisition request. For example, the ACL acquisition part 505 of the document management server 5 receives the SOAP response including the ACL from the policy server 2.

In Step S38, the encryption part 506 of the document management server 5 encrypts the original content data with an encryption key or such.

Then, in Step S39, the license data acquisition request part 507 of the document management server 5 sends the encryption key used for encrypting the original content data and/or the acquired ACL to the right management server 3, and requests license data therefrom.

The license data acquisition request receiving part 301 of the right management server 3 receives the license data acquisition request from the document management server 5.

The license data generating part 302 of the right management server 3 responds to the license data acquisition request, and generates license data based on the encryption key and/or the ACL included in the acquisition request.

In Step S40, the license data providing part 303 of the right management server 3 provides the license data generated in response to the license data acquisition request, to the document management server 5.

The license data acquisition part 508 in the document management server 5 receives the license data transmitted from the right management part 3 in response to the ACL acquisition request.

In Step S41, the license data attaching part 509 of the document management server 5 attaches the license data to the encrypted original content data. Thus, the protected content data is acquired.

Then, in Step S42, the protected content data storage/providing part 510 of the document management server 5 stores the encrypted original content data with the license data attached thereto (protected content data), or provides the protected content data to the reader terminal 4.

By means of the processing shown in FIG. 26 described above, processing is shared between the original content creator terminal 1 and the document management server 5, and the ACL can be attached to the document content data according to the organization's security policy.

In each of Steps S32, S33, S36, S37 and so forth of FIG. 26, as a result of communication being carried out with the use of SOAP as described above, communication can be carried out between the document management server 5 and the policy server 2 without regard to an OS or a program language.

Also in Step S34, S35 or such, communication may be carried out with the use of SOAP. Also in Step S39, S40 or such, communication may be carried out with the use of SOAP.

A fourth embodiment of the present invention is described.

In the third embodiment described above, the document management server 5 acquires an ACL from the policy server 2, and stores (holds) it in the HDD 59 or such. However, in this configuration, a user who has an access right of the document management server 5 may freely change the ACL, or an illegal user pretending to be a proper user who has an access right of the document management server 5 may freely change the ACL.

In order to avoid such a situation, according to the fourth embodiment, the policy server 2 itself holds and manages the ACL. By giving a right to change the ACL only to a manager or such of the policy server 2, a user who has an access right of the document management server 5 or an illegal user pretending to be a user who has an access right of the document management server 5 cannot freely change the ACL. For the propose of avoiding an illegal change of the ACL by a person pretending to be the manager of the policy server 2 for example, user authentication data in the policy server 2 should be updated frequently, for example. Hereinbelow, points different from the first, second and third embodiments are mainly described.

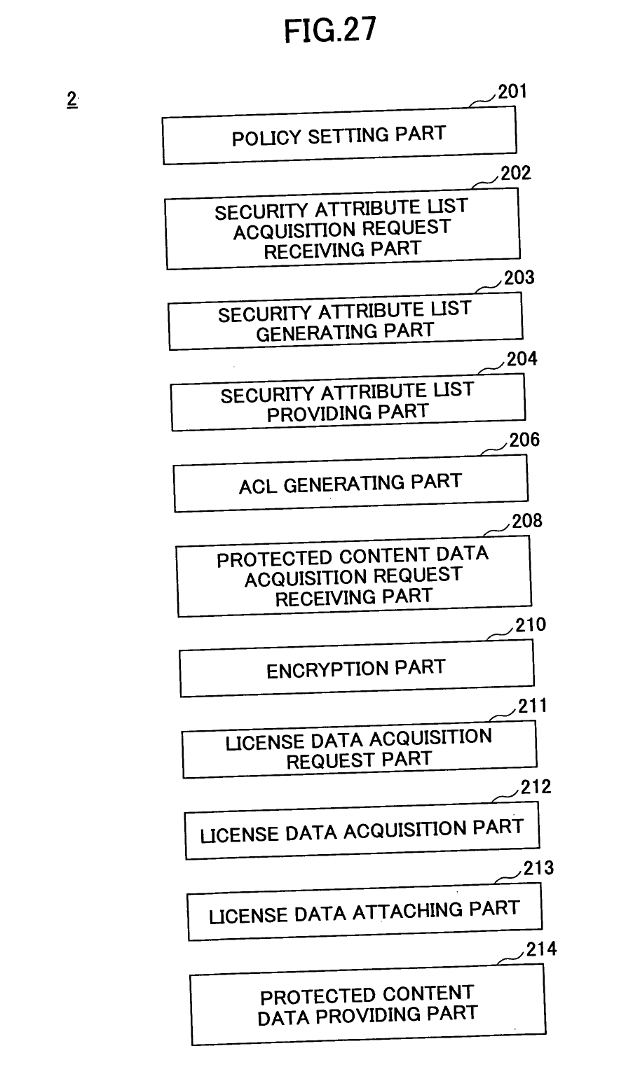

FIG. 27 shows a functional configuration of a policy server according to the fourth embodiment.

As shown in FIG. 27, the policy server 2 includes a policy setting part 201, a security attribute list acquisition request receiving part 202, a security attribute list generating part 203, a security attribute list providing part 204, an ACL generating part 206, a protected content data acquisition request receiving part 208, an encryption part 210, a license data acquisition request part 211, a license data acquisition part 212, a license data attaching part 213, and a protected content data providing part 214. The functional configuration of FIG. 27 is the same as that of FIG. 16.

However, the security attribute list acquisition request receiving part 202 of FIG. 27 receives a security list acquisition request from the document management server 5 for example.

Further, the security attribute list providing part 204 shown in FIG. 27 provides a security attribute list generated (or acquired) in response to a security attribute list acquisition request, to the document management sever 5 for example.

The protected content data acquisition request receiving part 208 of FIG. 27 receives protected content data acquisition request from the document management sever 5, for example.

The encryption part 210 encrypts original content data with the use of an encryption key. The encryption part 210 of FIG. 27 encrypts original content data acquired from the document management sever 5, for example, with the use of an encryption key stored in the RAM 26, the HDD 29 or such.

The protected content data providing part 214 of FIG. 27 provides protected content data (encrypted original content data having license data attached thereto) produced in response to a protected content data acquisition request, to the document management sever 5 for example.

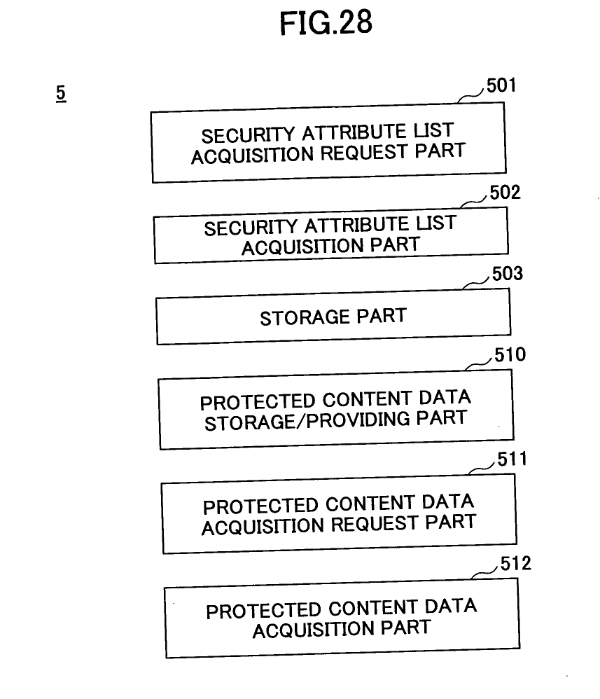

FIG. 28 shows a functional configuration of the document management server 5 according to the fourth embodiment.

As shown in FIG. 28, the document management server 5 includes a security attribute list acquisition request part 501, a security attribute list acquisition part 502, a storage part 503, a protected content data storage/providing part 510, a protected content data acquisition request part 511 and a protected content data acquisition part 512.

Functions of the security attribute list acquisition request part 501, the security attribute list acquisition part 502, the storage part 503 and the protected content data storage/providing part 510 are the same as those of the third embodiment described above.

The protected content data acquisition request part 511 transmits a protected content data acquisition request including original content data and a security attribute, to the policy server 2 or such.

The protected content data acquisition part 512 acquires protected content data transmitted in response to the protected content data acquisition request, from the policy server 2, for example.

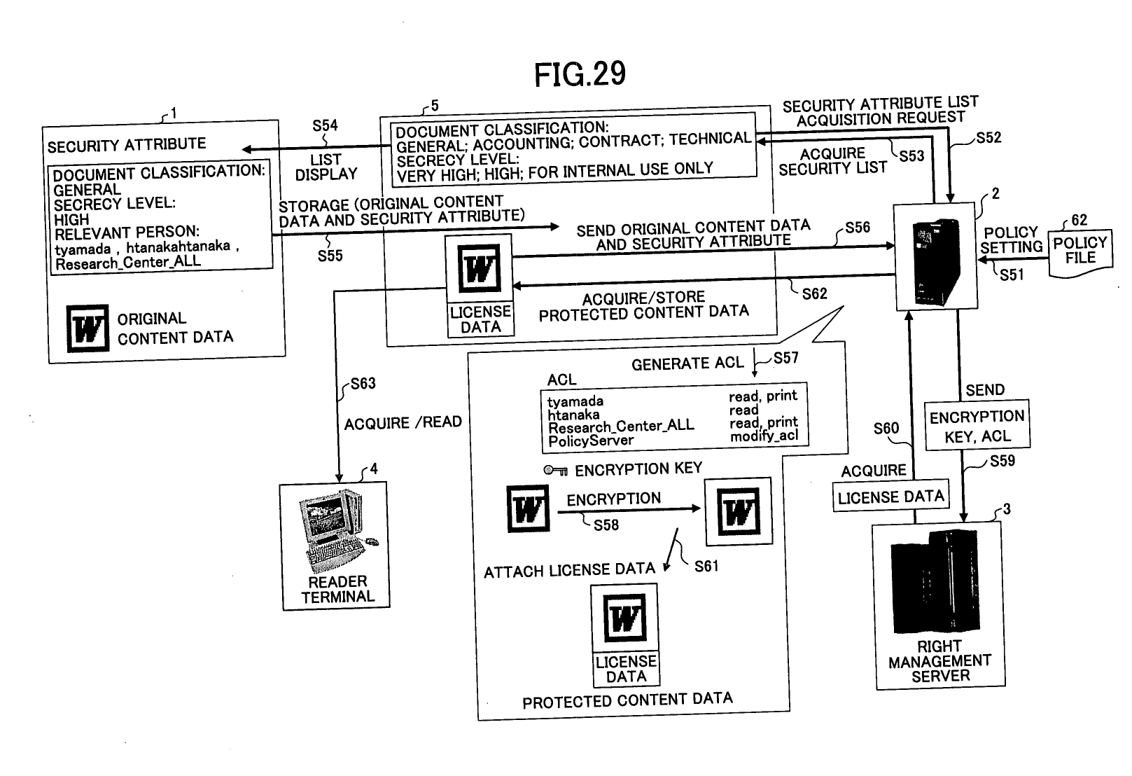

With reference to FIG. 29, one example of document ACL setting processing according to the fourth embodiment is described now. It is noted that a mark of an alphabet “W” enclosed by a square is a trademark of Microsoft Word.

First, in Step S51, the policy setting part 201 of the policy server 2 holds a security policy 61 of an organization set by a manager of the security server 2, in the HDD 29 or such in a form of a policy file 62.

In Step S52, the security attribute list acquisition request part 501 of the document management server 5 requests a security attribute list from the policy server 2 or such. For example, the security attribute list acquisition request part 501 of the document management server 5 transmits a SOAP request for reading a getSecurityLabels ( ) method to the policy server 2 as the security attribute list acquisition request.

The security attribute list acquisition request receiving part 202 of the policy server 2 receives the security attribute list acquisition request (SOAP request) from the document management server 5.

The security attribute list generating part 203 of the policy server 2 responds to the security attribute list acquisition request, to generate (or acquire) a security attribute list by executing the getSecurityLabels ( ) method, for example.

In Step S53, the security attribute list providing part 204 of the policy server 2 provides the security attribute list, thus generated (or acquired) in response to the security attitude list acquisition request, to the document management server 5. For example, the security attribute list providing part 204 acquires a returned value of the getSecurityLabels ( ) method as the security attribute list, includes it in a SOAP response, and transmits it to the document management server 5.

The security attribute list acquisition part 502 of the document management server 5 acquires the security attribute list transmitted from the policy server 2 in response to the security attribute list acquisition request. For example, the security attribute list acquisition part 502 receives the SOAP response including the security attributes list from the policy server 2.

In Step S54, the document registration part 111 of the original content creator terminal 1 reads the security attribute list of the document management server 5, and displays a security attribute setting page 80 including the security attribute list on the display device, and requests a user of the original content creator terminal 1 to register a document and to set a security attribute.

In Step S55, the storage request part 115 of the original content creator terminal 1 requests the document management server 5 to store a document and a security attribute thus registered (set) on the document registration page such as that shown in FIG. 19.

The storage part 503 of the document management server 5 responds to the storage request from the original content creator terminal 1, and stores the document and the security attribute in the RAM 56, the HDD 59 or such.

In Step S56, the protected content data acquisition request part 511 of the document management server 5 transmits a protected content acquisition request including the original content data and the security attribute, to the policy server 2. For example, the protected content data acquisition request part 511 of the document management part 5 transmits a SOAP request for reading a protectDocument ( ) method of the policy server 2 to the policy server 2 as the protected content data acquisition request.

The protected content data acquisition request receiving part 208 of the policy server 2 receives the protected content data acquisition request (SOAP request for reading the protectDocument ( ) method) from the document management server 5.

In Step S57, the ACL generating part 208 of the policy server 2 executes the protectDocument ( ) method based on the security attribute or such included in the protected content data acquisition request, and generates an ACL. It is noted that an ACL may be generated as a result of the protectDocument ( ) method executing the above-mentioned getACL ( ) method.

In Step S58, the encryption part 210 of the policy server 2 is called by the protectDocument ( ) method for example, and encrypts the original content data with an encryption key or such included in the protected content data acquisition request.

Then, in Step S59, the license data acquisition request part 211 of the policy server 2 is called by the protectDocument ( ) method for example, and requests license data from the right management server 4 or such by sending the encryption key used for encrypting the original data and/or the thus-generated ACL.

The license data acquisition request receiving part 301 of the right management server 3 receives the license data acquisition request from the policy server 2.

The license data generating part 302 of the right management server 3 responds to the license data acquisition request, and generates license data based on the encryption key and/or the ACL included in the acquisition request.

In Step S60, the license data providing part 303 provides the license data generated in response to the license data acquisition request, to the policy serer 2.

The license data acquisition part 212 of the policy server 2 is called by the protectDocument ( ) method for example, and receives the license data transmitted from the right management part 3 in response to the license data acquisition request.

In Step S61, the license data attaching part 213 of the policy server 2 is called by the protectDocument ( ) method for example and attaches the license data to the encrypted original content data. Thus, the protected content data is acquired.

Then, in Step S62, the protected content data providing part 214 of the policy server 2 is called by the protectDocument ( ) method for example, and provides the protected content data produced in response to the protected content data acquisition request (encrypted original content data with the license data attached thereto) to the document management server 5. For example, the protected content data providing part 214 of the policy server 2 acquires a returned value of the protectDocument ( ) method, includes it in a SOAP response, and transmits it to the document management server 5.

The protected content data acquisition part 512 of the document management server 5 acquires the protected content data transmitted from the policy server 2 in response to the protected content acquisition request. For example, the protected content data acquisition part 512 of the document management server 5 receives the SOAP response including the protected content data from the policy server 2.

Then, in Step S63, the protected content data storage/providing part 510 of the document management server 5 stores the encrypted original content data with the license data attached thereto (protected content data), or provides the protected content data to the reader terminal 4.

By means of the processing shown in FIG. 29 described above, processing is shared between the original content creator terminal 1 and the document management server 5, illegal change of ACL is effectively avoided, and the ACL can be attached to the document content data according to the organization's security policy.

In each of Steps S52, S53, S56, S62 and so forth of FIG. 29, as a result of communication being carried out with the use of SOAP as described above, communication can be carried out between the document management server 5 and the policy server 2 without regard to an OS or a program language.

Also in Step S54, S55 or such, communication may be carried out with the use of SOAP. Also in Step S59, S60 or such, communication may be carried out with the use of SOAP.

Further, the present invention is not limited to the above-described embodiments, and variations and modifications may be made without departing from the basic concept of the present invention claimed below.

The present application is based on Japanese Priority Application No. 2004-227911, filed on, Aug. 4, 2004, the entire contents of which are hereby incorporated herein by reference.

What is claimed is:

1. An access control list attaching system in which an original content creator terminal for creating original content data, a policy server producing a security policy file concerning the original content data and holding it in a storage part and a right management server managing a right concerning the original content data are connected via a communication network, wherein:
said policy server comprises an access control list generating part generating an access control list concerning the original content data based on an attribute of a security concerning the original content data and a security policy file in which the security policy is described.

2. The access control list attaching system as claimed in claim 1, wherein:
the attribute of the security comprises a secrecy level of the original content data.

3. The access control list attaching system as claimed in claim 1, wherein:
said original content creator terminal comprises:
an encryption part encrypting the original content data with the use of an encryption key; and
a license data attaching part attaching license data, concerning the original content data, acquired from the right management server, with the use of the access control list and the encryption key, to the encrypted original content data.

4. The access control list attaching system as claimed in claim 1, wherein:
said access control list attaching system further comprises an original content data management server managing the original content data;
said original content data management server comprises:
an encryption part encrypting the original content data with the use of an encryption key; and
a license data attaching part attaching license data, concerning the original content data, acquired from the right management server, with the use of the access control list and the encryption key, to the encrypted original content data.

5. The access control list attaching system as claimed in claim 4, wherein:
said original content data management server further comprises a providing part providing the encrypted original content data having the license data attached thereto to a reader terminal connected with the access control list attaching system via a communication network.

6. The access control list attaching system as claimed in claim 2, wherein:
the attribute of the security further comprises a document classification of the original content data and a relevant person representing a discloseable scope of the original content data.

7. The access control list attaching system as claimed in claim 1, wherein:
said original content creator terminal comprises a setting part for setting the attribute of the security.

8. The access control list attaching system as claimed in claim 1, wherein:
communication in the access control list attaching system is carried out based on SOAP.

9. An original content creator terminal for creating original content data comprising:
a setting part for setting an attribute of a security concerning the original content data;
an encryption part encrypting the original content data with the use of an encryption key; and
a license data attaching part attaching license data concerning the original content data, acquired from a right management server managing a right concerning the original content data, with the use of an access control list concerning the original content data acquired from a policy server generating a policy file concerning the original content data and holding it in a storage part, with the use of the attribute of the security, and the encrypted key, to the encrypted original content data.

10. The original content creator terminal as claimed in claim 9, wherein:
the attribute of the security comprises a secrecy level of the original content data.

11. The original content creator terminal as claimed in claim 10, wherein:
the attribute of the security further comprises a document classification of the original content data and a relevant person representing a discloseable scope of the original content data.

12. A policy server generating a policy file concerning original content data, and holding it in a storage part, comprising:
an access control list generating part generating an access control list concerning the original content data based on an attribute of a security concerning the original content data and a security policy file in which a security policy is described.

13. The policy server as claimed in claim 12, wherein:
the attribute of the security comprises a secrecy level of the original content data.

14. The policy server as claimed in claim 13, wherein:
the attribute of the security further comprises a document classification of the original content data and a relevant person representing a discloseable scope of the original content data.

15. The policy server as claimed in claim 12, comprising:
an encryption part encrypting the original content data with the use of an encryption key; and
a license data attaching part attaching license data, concerning the original content data, acquired from a right management server managing a right concerning the original content data, with the use of the access control list and the encryption key, to the encrypted original content data.

16. An original content data management server managing original content data, comprising:
an encryption part encrypting the original content data with the use of an encryption key; and
a license data attaching part attaching license data, concerning the original content data, acquired from a right management server which manages a right concerning the original content data, with the use of an access control list concerning the original content data acquired from a policy server generating a policy file and holding it in a storage part, with the use of an attribute of a security concerning the original content data, and the encryption key, to the encrypted original content data.

17. The original content management server as claimed in claim 16, wherein:
the attribute of the security comprises a secrecy level of the original content data.

18. The original content management server as claimed in claim 16, wherein:
the attribute of the security further comprises a document classification of the original content data and a relevant person representing a discloseable scope of the original content data.

19. A program comprising instructions for causing a computer to act as:
a setting part for setting an attribute of a security concerning the original content data;
an encryption part encrypting the original content data with the use of an encryption key; and
a license data attaching part attaching license data concerning the original content data, acquired from a right management server managing a right concerning the original content data, with the use of an access control list concerning the original content data acquired from a policy server generating a policy file concerning the original content data and holding it in a storage part, with the use of the attribute of security, and the encryption key, to the encrypted original content data.

20. A program comprising instructions for causing a computer to act as:
an access control list generating part generating an access control list concerning original content data based on an attribute of a security concerning the original content data and a security policy file in which a security policy is described.

21. A program comprising instructions for causing a computer to act as:
an encryption part encrypting original content data with the use of an encryption key; and
a license data attaching part attaching license data concerning the original content data acquired from a right management server which manages a right concerning the original content data, with the use of an access control list concerning the original content data acquired from a policy server generating a policy file and holding it in a storage part, with the use of an attributive a security concerning the original content data, and the encryption key, to the encrypted original content data.

22. A computer readable information recording medium storing therein the program claimed in claim 19.

23. A computer readable information recording medium storing therein the program claimed in claim 20.

24. A computer readable information recording medium storing therein the program claimed in claim 21.
